(19) United States
(12) Patent Application Publication
(10) Pub. No.: US 2003/0162854 A1
(43) Pub. Date: Aug. 28, 2003

(54) Fire-resistant polyolefin

(76) Inventors: Jean Pierre Mayeres, Eupen (BE); Veronique Paquay, Timister (BE)

Correspondence Address: Melvin I Stoltz, 51 Cherry Street, Milford, CT, 06460, US

(21) Appl. No.: 10/312,452

(22) PCT Filed: Jun. 25, 2001
(86) PCT No.: PCT/EP01/07198

(30) Foreign Application Priority Data
Jun. 30, 2000 (EP) 00113862.7

(51) Int. Cl. C08J 9/00

(52) U.S. Cl. 521/82; 521/142

(57) ABSTRACT

The invention concerns a fire-resistant polyolefin comprising between 5 and 90% of chlorinated polyethylene, a method for preparing them and their use for making foams or thermoformed products. The invention also concerns the resulting foams and thermoformed products and the use of the resulting foams.

The present invention relates to foam of flame-retardant polyolefin, a method for their preparation, and the use of the foams obtained.

It is known that flame-retardant agents can be added to polyolefins in order to enhance their fire-resistance. The additives normally used are, for example, antimony trioxide, ammonium sulphate and borax, as well as metallic hydroxides. The amounts of these materials necessary to obtain an acceptable degree of fire-resistance generally affect the mechanical properties of the finished product. Moreover, in view of their high concentration, there is a risk of such flame-retardant additives migrating to the surface of the product. Their uniform distribution within the product is thus no longer guaranteed.

The object of the present invention is to propose a foam of polyolefin without these disadvantages or having them to a lesser extent.

The invention also has as an object a process for the manufacture of foams, and the use of the foams obtained to manufacture insulating jackets.

In conformity with the invention, this objective is reached by a foam comprising a flame-retardant polyolefin composition characterised in that the polyolefin is chosen from among the group consisting of polyethylene and polypropylene, their copolymers and mixtures of these products and in that the foam comprises between 5% and 90% of chlorinated polyethylene.

One of the advantages of such a polyolefin foam is that it has acceptable flame-retardant properties without the risk of the flame-retardant additives migrating.

The absence or the low percentage of standard flame-retardant additives also has a beneficial effect on the mechanical properties of the polyolefin. Furthermore, the incorporation of chlorinated polyethylene increases the flexibility of polyolefin compositions.

The compositions according to the invention are generally characterised by a chlorinated polyethylene concentration that is greater than or equal to 5%, preferably greater than or equal to 15% and, in particular, preferably greater than or equal to 30%.

The compositions according to the invention are generally characterised by a chlorinated polyethylene concentration that is less than or equal to 90%, preferably less than or equal to 75% and, in particular, preferably less than or equal to 60%.

The polyolefin is preferably chosen from among the group consisting of polyethylene and polypropylene, their copolymers and mixtures of these products.

The addition of metallocene i.e. of a polymer having a very narrow molecular distribution and a repartition of comonomers (f.ex. butene, hexene, octene, . . . ) which is very uniform may also enhance the quality of the foam.

Advantageously, the composition of polyolefins may also comprise between 2% and 30% of a metallocene.

The compositions according to the invention are generally characterised by a metallocene concentration that is greater than or equal to 2%, preferably greater than or equal to 5%, in particular, preferably greater than or equal to 7%.

The compositions according to the invention are generally characterised by a metallocene concentration that is less than or equal to 30%, preferably less than or equal to 20% and, in particular, preferably less than or equal to 15%.

The polyolefin composition according to the invention may or may not be reticulated. According to a particular mode of execution, the composition of the flame-retardant polyolefin is not reticulated, which has the advantage that the product may be recycled.

Advantageously, the composition of the flame-retardant polyolefin also comprises in addition to antimony trioxide another standard flame-retardant additive. In view of the fact that the polyolefin compositions according to the present invention have intrinsic flame-retardant properties, the quantity of traditional flame-retardant additives necessary is small. The mechanical properties are affected very little or not at all. Moreover, the risk of migration of these additives is minimised.

The foam preferably mainly comprises closed cells.

Such foams have the advantage of being more flexible than traditional polyolefin foams.

Moreover, they have no special smell.

A particularly significant usage of this flame-retardant polyolefin is as an insulating material and/or as a shaped section. When these foams are used as insulating jackets for hot water pipes, for example, it is possible to form 90° bends without having to cut the jacket. Standard jackets made of polyethylene foam are more rigid and have to be cut to form 90° angles. Jackets according to the invention are therefore installed on site more easily and quickly.

According to another aspect of the present invention, a method of manufacturing a flame-retardant polyolefin foam is also proposed in which the polyolefin is mixed while hot with chlorinated polyethylene and possibly with the usual admixtures and additives and is then extruded. Among such additives may be quoted those that are anti-static, anti-UV, antioxidant, or that are pigments, bulk stabilisers and nucleating agents.

A polyolefin is mixed while hot with the chlorinated polyethylene in an extruder; a foaming agent is added and the mixture thus obtained is extruded in order to obtain a foam.

The choice of foaming agent is not critical. In general, all the foaming agents traditionally used for foaming polyolefins may also lie within the scope of the present invention. Advantageously, isobutane is used either alone or mixed with another foaming agent.

The equipment used for the manufacture of ordinary polyolefin foams may be used in the manufacture of flame-retardant polyolefin foams.

An advantageous mode of execution of the invention is described below as an illustrative example.

### EXAMPLE 1

The chlorinated polyethylene used in the context of the present invention is manufactured by Du Pont Dow and is marketed under the name TYRIN 3652P.

For producing foams and in order to obtain a stable foam of acceptable quality, it is preferable for the chlorinated polyethylene to contain only small amounts of antiblocking agents.

Concentrations of such antiblocking agents that are too high make it difficult to manufacture foams of an acceptable quality. In particular, it has been found advantageous for the chlorinated polyethylene to contain little or no calcium stearate.

Maximum concentrations of 6% of talc and 3% of calcium carbonate enabled high-grade foams to be obtained.

A closed-cell foam has been obtained from:

45.5% (by weight) of the chlorinated polyethylene described above,

35.5% (by weight) of polyethylene, (LDPE, density 921 kg/m³)

8.9% (by weight) of metallocene, (comonomer hexene)

6.2% (by weight) of antimony trioxide,

2.2% (by weight) of steramide,

1.65% (by weight) of soybean oil (thermal stabilizer).

The foaming agent used was isobutane.

Foam tubes with a density of 30 kg/m³ were subjected to a test in order to determine the maximum bending force required to produce a bending of 50 mm.

The maximum bending force was approximately 44 N for a sample of the aforesaid foam while a sample of a traditional LDPE foam required a maximum bending force of approximately 102 N. The samples had the same inner and outer diameters and the same density.

Various other formulations were tested and enabled foams of different densities to be obtained. In addition to their good flexibility, these foams have a better fire-resistance than foams not incorporating chlorinated polyethylene:

### EXAMPLE 2

45.5 parts of chlorinated polyethylene (DuPont Dow Tyrin)

45 parts of LDPE (density 921 kg/m3)

10 parts of antimony trioxide

2 parts of pigments (carbon black)

2 parts of surfactant (steramide)

2 parts of thermal stabilizer (epoxidized soybean oil)

### EXAMPLE 3

30 parts of LDPE (density 921 kg/m3)

70 parts of chlorinated polyethylene (Du Pont Dow Tyrin)

2 parts of surfactant (steramide)

2 parts of pigments (carbon black)

### EXAMPLE 4

40 parts of LDPE (density 921 kg/m3)

60 parts of chlorinated polyethylene (Du Pont Dow Tyrin)

4.8 parts of antimony trioxide

2 parts of surfactant (steramide)

2 parts of pigments (carbon black)

### EXAMPLE 5

50 parts of LDPE

50 parts of chlorinated polyethylene (PCE 140B from Tianteng Chemical Co)

7.5 parts of surfactant (steramide)

3 parts of pigments (carbon black)

### EXAMPLE 6

60 parts of LDPE

40 parts of chlorinated polyethylene (Hoechst Pe-c 4135h)

2 parts of surfactant (steramide)

2 parts of pigments (carbon black)

### EXAMPLE 7

50 parts of chlorinated polyethylene (Dupont Dow Tyrin)

38 parts of LDPE

5 parts of flame-retardant (brominated type)

7 parts of antimony trioxide

5 parts of pigments (carbon black)

3 parts of surfactant (steramide)

10 parts of metallocene (comonomer hexene)

1 part of aluminum

2 parts of thermal stabilizer (epoxidized soybean oil)

### EXAMPLE 8

51 parts of chlorinated polyethylene (Dupont Dow Tyrin)

40 parts of LDPE (density 921 kg/m3)

7 parts of antimony trioxide

5 parts of pigments (carbon black)

3 parts of surfactant (steramide)

10 parts of metallocene (comonomer hexene)

2 parts of thermal stabilizer (epoxidized soybean oil)

### EXAMPLE 9

51 parts of chlorinated polyethylene (Dupont Dow Tyrin)

40 parts of LDPE (density 921 kg/m3)

7 parts of antimony trioxide

2 parts of pigments (carbon black)

3 parts of surfactant (glycerol monostearat)

10 parts of metallocene (comonomer hexene)

2 parts of thermal stabilizer (epoxidized soybean oil)

1. Foam comprising a flame-retardant polyolefin composition, characterised in that the polyolefin is chosen from among the group consisting of polyethylene and polypropylene, their copolymers and mixtures of these products and in that the foam comprises in addition between 5% and 90% of chlorinated polyethylene.

2. Flame-retardant polyolefin composition according to claim 1, characterised in that it comprises, in addition, between 2% and 30% of metallocene.

3. Foam according to claim 1, characterised in that the polyolefin is not reticulated.

4. Foam according to claim 1, characterised in that the polyolefin is reticulated.

5. Foam according to any one of the preceding claims, characterised in that it comprises, in addition, antimony trioxide.

6. Foam according to any one of the preceding claims, characterised in that it comprises furthermore antistatic, anti-UV additives, antioxydants, pigments, volume stabilizers or nucleating agents.

7. Foam according to any one of claims 1 to 6, characterised in that it comprises maximum concentrations of 6% of talc and of 3% of calcium carbonate.

8. Foam according to any one of the preceding claims, characterised in that it mainly comprises closed cells.

9. Use of the foam according to any one of the preceding claims, for the manufacture of insulating jackets.

10. Method for manufacturing a foam according to any one of claims 1 to 7, characterised in that the polyolefin is mixed, while hot, with chlorinated polyethylene and optionally with metallocene, in that a foaming agent is added to the extruder and in that the mixture thus obtained is extruded in order to obtain a foam.
